(19) United States
(12) Patent Application Publication
(10) Pub. No.: US 2020/0136779 A1
(43) Pub. Date: Apr. 30, 2020

(54) Overhead Reduction In Transmission of Small Ethernet Packets Over A Wireless Link

(71) Applicant: MediaTek Singapore Pte. Ltd., Singapore (SG)

(72) Inventors: Mukesh Chouhan, Cambridge (GB); Pradeep Jose, Cambridge (GB)

(21) Appl. No.: 16/667,897

(22) Filed: Oct. 29, 2019

Related U.S. Application Data
(60) Provisional application No. 62/752,383, filed on Oct. 30, 2018.

(51) Int. Cl. H04L 5/00; H04L 12/26; H04W 76/10

(52) U.S. Cl. CPC H04L 5/0053; H04W 76/10; H04L 43/18

(57) ABSTRACT

Various examples and schemes pertaining to overhead reduction in transmission of small Ethernet packets are described. When an apparatus receives a first packet over a wired link, with the first packet comprising a plurality of data bits and one or more first padding bytes, the apparatus removes the one or more first padding bytes from the first packet to provide an unpadded packet. The apparatus then transmits the unpadded packet over a wireless link. When the apparatus receives a second packet over the wireless link, the apparatus inserts one or more second padding bytes into the second packet to provide a padded packet having a length equal to a predefined minimum desired packet length. The apparatus also transmits the padded packet over the wired link.

### CROSS REFERENCE TO RELATED PATENT APPLICATION(S)

The present disclosure is part of a non-provisional application claiming the priority benefit of U.S. Patent Application No. 62/752,383, filed on 30 Oct. 2018, the content of which being incorporated by reference in its entirety.

### TECHNICAL FIELD

The present disclosure is generally related to digital communications and, more particularly, to techniques pertaining to overhead reduction in transmission of small Ethernet packets.

### BACKGROUND

Unless otherwise indicated herein, approaches described in this section are not prior art to the claims listed below and are not admitted as prior art by inclusion in this section.

Ethernet is a computer networking technology commonly used for transmitting datagrams in a local and wide area networks (LAN/WAN). The basic unit of data transmission over an Ethernet network is known as a frame that defines the protocol data unit at the Open Systems Interconnection (OSI) Layer 2 (L2) link level or a packet that defines the protocol data unit at the OSI Layer 3 (L3). Ethernet has a minimum packet size no less than 64 bytes that include two 6-byte addresses, 2 bytes of type or length, 4 bytes for cyclic redundancy check (CRC), and 46 bytes of data. The number of data bytes may be reduced by 4 bytes to 42 bytes if 4 bytes for virtual local area network (VLAN) are present. Typically, if a host has less than 46 bytes (or 42 bytes with VLAN) of data to send, the host adds padding bytes to extend the data to 46 bytes (or 42 bytes with VLAN). In wireless communications, there is a desire to transmit as few bytes as possible to maximize the scarce radio resources.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure aims to propose concepts, solutions, schemes, techniques, designs, methods and apparatus pertaining to techniques pertaining to overhead reduction in transmission of small Ethernet packets. Specifically, various schemes proposed herein aim to omit transmission of padding byes over a wireless connection link between two communication peers to reduce overhead.

In one aspect, a method may involve a processor of an apparatus receiving a packet over a wired link, the packet comprising a plurality of data bits and one or more padding bytes. The method may also involve the processor removing the one or more padding bytes from the packet to provide an unpadded packet. The method may further involve the processor transmitting the unpadded packet over a wireless link.

In one aspect, a method may involve a processor of an apparatus receiving a packet over a wireless link. The method may also involve the processor inserting one or more padding bytes into the packet to provide a padded packet having a length equal to a predefined minimum desired packet length. The method may further involve the processor transmitting the padded packet over a wired link.

In one aspect, an apparatus may include a transceiver, a modem and a processor coupled to the transceiver and the modem. The transceiver may be configured to transmit and receive over a wireless link. The modem may be configured to transmit and receive over a wired link. The processor may be configured to perform operations including: (a) receiving, via the modem, a first packet over the wired link, the first packet comprising a plurality of data bits and one or more first padding bytes; (b) removing the one or more first padding bytes from the first packet to provide an unpadded packet; and (c) transmitting, via the transceiver, the unpadded packet over the wireless link. The processor may be further configured to perform operations including: (d) receiving, via the transceiver, a second packet over the wireless link; (e) inserting one or more second padding bytes into the second packet to provide a padded packet having a length equal to a predefined minimum desired packet length; and (f) transmitting, via the modem, the padded packet over the wired link.

It is noteworthy that, although description provided herein may be in the context of certain radio access technologies, networks and network topologies such as Ethernet, the proposed concepts, schemes and any variation(s)/derivative(s) thereof may be implemented in, for and by other types of radio access technologies, networks and network topologies such as, for example and without limitation, 5^{th} Generation (5G), New Radio (NR), Long-Term Evolution (LTE), LTE-Advanced, LTE-Advanced Pro, narrowband (NB), narrowband Internet of Things (NB-IoT), Wi-Fi, infrared, Bluetooth and any future-developed networking and communication technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example format of a smallest Ethernet packet with which various solutions and schemes in accordance with the present disclosure may be implemented.

FIG. 2 is a diagram of an example networking scenario in accordance with an implementation of the present disclosure.

FIG. 3 is a diagram of an example mechanism in accordance with an implementation of the present disclosure.

FIG. 4 is a diagram of an example mechanism in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to overhead reduction in transmission of small Ethernet packets. According to the present disclosure, a number of possible solutions may be implemented separately or jointly. That is, although these possible solutions may be described below separately, two or more of these possible solutions may be implemented in one combination or another.

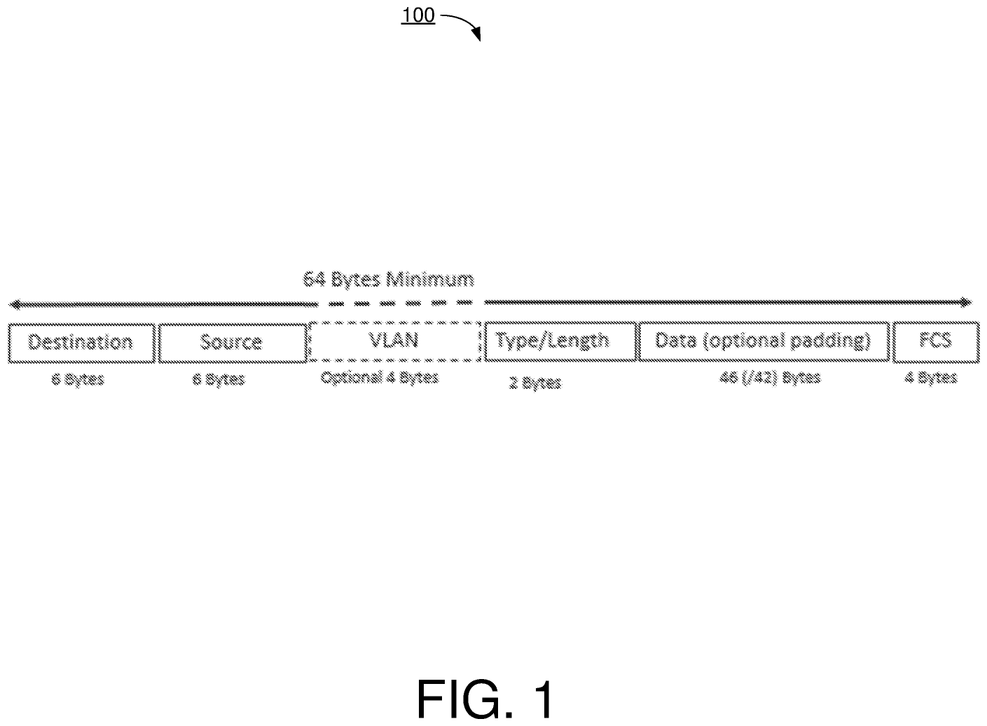

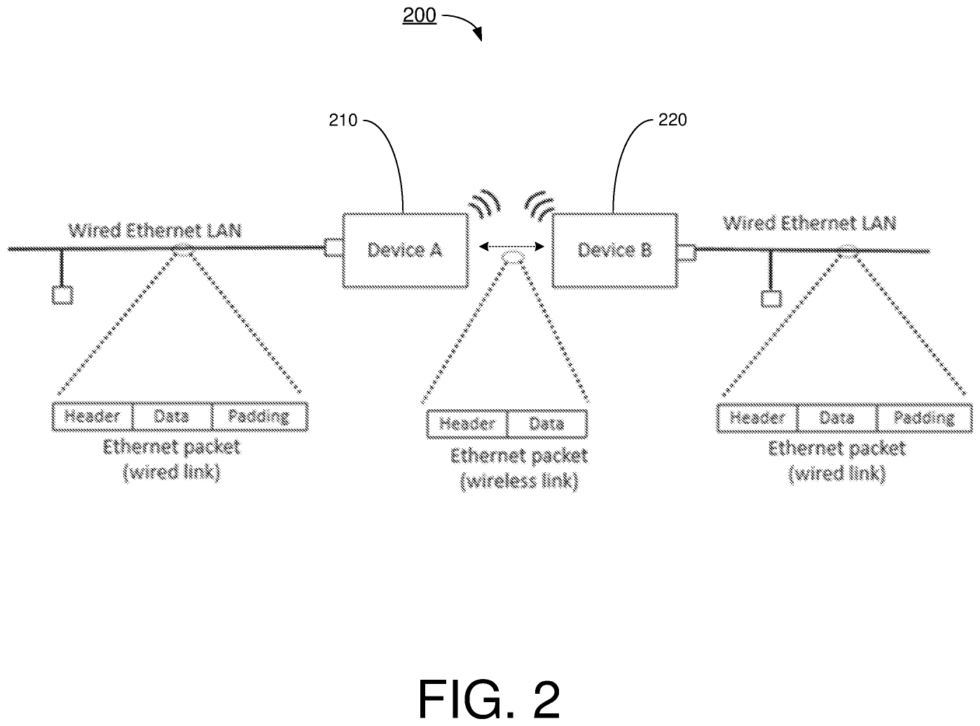

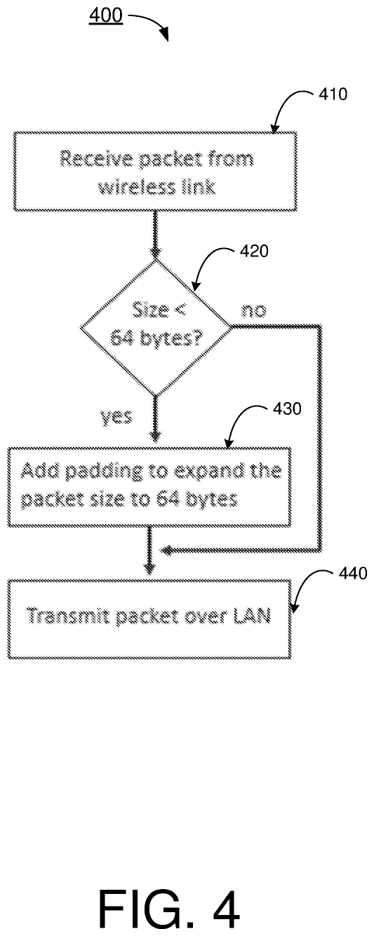

FIG. 1 illustrates an example format of a smallest Ethernet packet 100 with which various solutions and schemes in accordance with the present disclosure may be implemented. Referring to FIG. 1, packet 100 may include padding bytes in an event that there is insufficient data. Packet 100 may be an example Ethernet packet described below with reference to FIG. 2˜FIG. 4.

Under various proposed schemes in accordance with the present disclosure, padding bytes may be removed from Ethernet packet 100 and the resultant unpadded packet may be transmitted over a wireless link. Under various proposed schemes in accordance with the present disclosure, after an unpadded packet is received over a wireless link, padding bytes may be automatically inserted or otherwise added to the packet before the resultant padded packet (e.g., Ethernet packet 100) is transmitted over a wired link.

FIG. 2 illustrates an example networking scenario 200 in accordance with an implementation of the present disclosure. Referring to FIG. 2, networking scenario may involve an apparatus 210 and an apparatus 220 in wireless communication with each other. Scenario 200 shows transformation of Ethernet packets as each packet traverse wired and wireless connections under various proposed schemes in accordance with the present disclosure, as described below.

Under a proposed scheme in accordance with the present disclosure, apparatus 210 may receive, over a wired link (e.g., a link of a wired Ethernet LAN), a padded Ethernet packet that includes a header, data and padding, and apparatus 210 may transmit a portion of the padded Ethernet packet to apparatus 220 over a wireless link (e.g., a 3^{rd} Generation Partnership Project (3GPP)-compliant access such as 5G/NR or a non-3GPP access such as Wi-Fi, infrared or Bluetooth). That is, apparatus 210 may remove the padding from the padded Ethernet packet and then wirelessly transmit just the header and data to apparatus 220. Upon receiving the header and data, apparatus 220 may reconstruct the padded Ethernet packet by adding padding to the header and data, and apparatus 220 may transmit the padded Ethernet packet over a wired link (e.g., a link of a wired Ethernet LAN).

Likewise, under the proposed scheme, apparatus 220 may receive, over a wired link (e.g., a link of a wired Ethernet LAN), a padded Ethernet packet that includes a header, data and padding, and apparatus 220 may transmit a portion of the padded Ethernet packet to apparatus 210 over a wireless link (e.g., a 3GPP access such as 5G/NR or a non-3GPP access such as Wi-Fi, infrared or Bluetooth). That is, apparatus 220 may remove the padding from the padded Ethernet packet and then wirelessly transmit just the header and data to apparatus 210. Upon receiving the header and data, apparatus 210 may reconstruct the padded Ethernet packet by adding padding to the header and data, and apparatus 210 may transmit the padded Ethernet packet over a wired link (e.g., a link of a wired Ethernet LAN).

Accordingly, for an Ethernet packet with data of a small size such that padding is added to the packet, overhead reduction may be achieved for transmission over a wireless link as padding is removed from the packet between a transmitting entity (e.g., apparatus 210) and a receiving entity (e.g., apparatus 220). That is, the wireless transmission between the transmitting entity and the receiving entity involves transmission of the header and data of the original Ethernet packet without the padding. Padding may be added on the receiving side to reconstruct the original padded Ethernet packet.

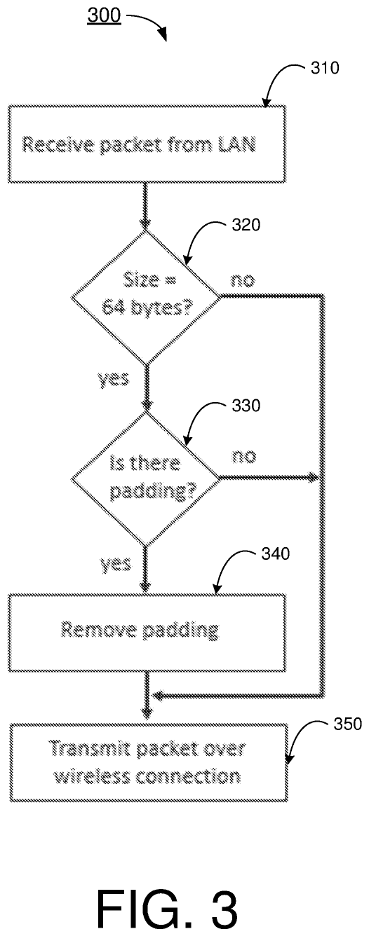

FIG. 3 illustrates an example mechanism 300 in accordance with an implementation of the present disclosure. Referring to FIG. 3, mechanism 300 may involve a number of operations and/or actions performed by a transmitting entity (e.g., apparatus 210), as represented by one or more of blocks 310, 320, 330, 340 and 350. Although illustrated as discrete blocks, various blocks of mechanism 300 may be divided into additional blocks, combined into fewer blocks, or eliminated, depending on the desired implementation. Mechanism 300 may begin at 310.

At 310, mechanism 300 may involve apparatus 210 receiving a packet over a wired link (e.g., a LAN). Mechanism 300 may proceed from 310 to 320.

At 320, mechanism 300 may involve apparatus 210 determining whether a size of the packet. Depending on whether the size of the packet is 64 bytes, mechanism 300 may proceed from 320 to 330 in case the size of the packet is 64 bytes or proceed from 320 to 350 in case the size of the packet is not 64 bytes.

At 330, mechanism 300 may involve apparatus 210 determining whether there is padding in the received packet. Depending on whether there is padding in the received packet, mechanism 300 may proceed from 330 to 340 in case there is padding in the received packet or proceed from 330 to 350 in case there is no padding in the received packet.

At 340, mechanism 300 may involve apparatus 210 removing padding from the received packet. Mechanism 300 may proceed from 340 to 350.

At 350, mechanism 300 may involve apparatus 210 transmitting the unpadded packet over a wireless link (e.g., a 3GPP connection or a non-3GPP connection).

Thus, under mechanism 300, padding may be removed while data is kept in a packet, and the packet, absent of padding, may be transmitted over a wireless link so as to achieve overhead reduction.

FIG. 4 illustrates an example mechanism 400 in accordance with an implementation of the present disclosure. Referring to FIG. 4, mechanism 400 may involve a number of operations and/or actions performed by a transmitting entity (e.g., apparatus 220), as represented by one or more of blocks 410, 420, 430 and 440. Although illustrated as discrete blocks, various blocks of mechanism 400 may be divided into additional blocks, combined into fewer blocks, or eliminated, depending on the desired implementation. Mechanism 400 may begin at 410.

At 410, mechanism 400 may involve apparatus 200 receiving a packet over a wireless link (e.g., a 3GPP connection or a non-3GPP connection). Mechanism 400 may proceed from 410 to 420.

At 420, mechanism 300 may involve apparatus 220 determining whether a size of the packet. Depending on whether the size of the packet is less than 64 bytes, mechanism 400 may proceed from 420 to 430 in case the size of the packet is less than 64 bytes or proceed from 420 to 440 in case the size of the packet is not less than 64 bytes.

At 430, mechanism 400 may involve apparatus 200 adding padding to expand the size of the received packet to 64 bytes. Mechanism 400 may proceed from 430 to 440.

At 440, mechanism 300 may involve apparatus 220 transmitting the packet over a wired link (e.g., a LAN).

Thus, under mechanism 400, when the size of a received packet is below the minimum Ethernet frame size (e.g., 64 bytes), the data component of the packet may be expanded with padding to restore the original minimum frame size.

### Illustrative Implementations

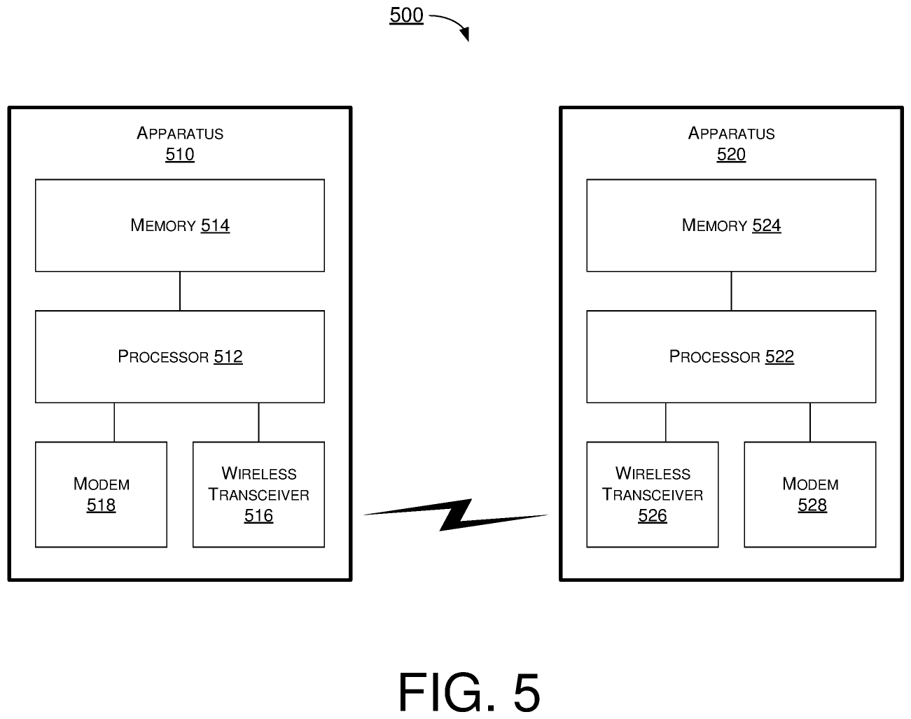

FIG. 5 illustrates an example communication system 500 having an example apparatus 510 and an example apparatus 520 in accordance with an implementation of the present disclosure. Each of apparatus 510 and apparatus 520 may perform various functions to implement schemes, techniques, processes and methods described herein pertaining to overhead reduction in transmission of small Ethernet packets, including various schemes described above as well as processes described below.

Each of apparatus 510 and apparatus 520 may be a part of an electronic apparatus, which may be a UE such as a vehicle, a portable or mobile apparatus, a wearable apparatus, a wireless communication apparatus or a computing apparatus. For instance, each of apparatus 510 and apparatus 520 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 510 and apparatus 520 may also be a part of a machine type apparatus, which may be an IoT or NB-IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. Alternatively, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Each of apparatus 510 and apparatus 520 may include at least some of those components shown in FIG. 5 such as a processor 512 and a processor 522, respectively. Each of apparatus 510 and apparatus 520 may further include one or more other components not pertinent to the proposed scheme of the present disclosure (e.g., internal power supply, display device and/or user interface device), and, thus, such component(s) of each of apparatus 510 and apparatus 520 are neither shown in FIG. 5 nor described below in the interest of simplicity and brevity.

In some implementations, at least one of apparatus 510 and apparatus 520 may be a part of an electronic apparatus, which may be a vehicle, a roadside unit (RSU), network node or base station (e.g., eNB, gNB or TRP), a small cell, a router or a gateway. For instance, at least one of apparatus 510 and apparatus 520 may be implemented in a vehicle in a vehicle-to-vehicle (V2V) or vehicle-to-everything (V2X) network, an eNodeB in an LTE, LTE-Advanced or LTE-Advanced Pro network or in a gNB in a 5G, NR, IoT or NB-IoT network. Alternatively, at least one of apparatus 510 and apparatus 520 may be implemented in the form of one or more IC chips such as, for example and without limitation, one or more single-core processors, one or more multi-core processors, or one or more CISC or RISC processors.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including overhead reduction in transmission of small Ethernet packets in accordance with various implementations of the present disclosure.

In some implementations, apparatus 510 may also include a wireless transceiver 516 coupled to processor 512 and capable of wirelessly transmitting and receiving data over a wireless link (e.g., a 3GPP connection or a non-3GPP connection). In some implementations, apparatus 510 may further include a modem 518 coupled to processor 512 and capable of transmitting and receiving data over a wired link (e.g., a LAN). In some implementations, apparatus 510 may further include a memory 514 coupled to processor 512 and capable of being accessed by processor 512 and storing data therein. In some implementations, apparatus 520 may also include a wireless transceiver 526 coupled to processor 522 and capable of wirelessly transmitting and receiving data over a wireless link (e.g., a 3GPP connection or a non-3GPP connection). In some implementations, apparatus 520 may further include a modem 528 coupled to processor 522 and capable of transmitting and receiving data over a wired link (e.g., a LAN). In some implementations, apparatus 520 may further include a memory 524 coupled to processor 522 and capable of being accessed by processor 522 and storing data therein. Accordingly, apparatus 510 and apparatus 520 may wirelessly communicate with each other via transceiver 516 and transceiver 526, respectively.

To aid better understanding, the following description of the operations, functionalities and capabilities of each of apparatus 510 and apparatus 520 is provided in the context of an NR communication environment in which apparatus 510 is implemented in or as a wireless communication device, a communication apparatus, a UE or an IoT device (e.g., apparatus 210) and apparatus 520 is implemented in or as a wireless communication device, a communication apparatus, a UE or an IoT device (e.g., apparatus 220).

In one aspect of overhead reduction in transmission of small Ethernet packets in accordance with the present disclosure, processor 512 of apparatus 510 may receive, via modem 518, a first packet over a wired link, with the first packet including a plurality of data bits and one or more first padding bytes. Processor 512 may remove the one or more first padding bytes from the first packet to provide an unpadded packet. Processor 512 may also transmit, via transceiver 516, the unpadded packet over a wireless link. Processor 522 of apparatus 520 may be configured to perform the same operations.

In another aspect of overhead reduction in transmission of small Ethernet packets in accordance with the present disclosure, processor 512 of apparatus 510 may receive, via transceiver 516, a second packet over the wireless link. Processor 512 may insert one or more second padding bytes into the second packet to provide a padded packet having a length equal to a predefined minimum desired packet length. Processor 512 may then transmit, via modem 518, the padded packet over the wired link. Processor 522 of apparatus 520 may be configured to perform the same operations.

Each of apparatus 510 and apparatus 520 may be configured to perform additional operations. In the interest of brevity, additional capabilities and functions of each of apparatus 510 and apparatus 520 are described below with respect to processes 600 and 700.

### Illustrative Processes

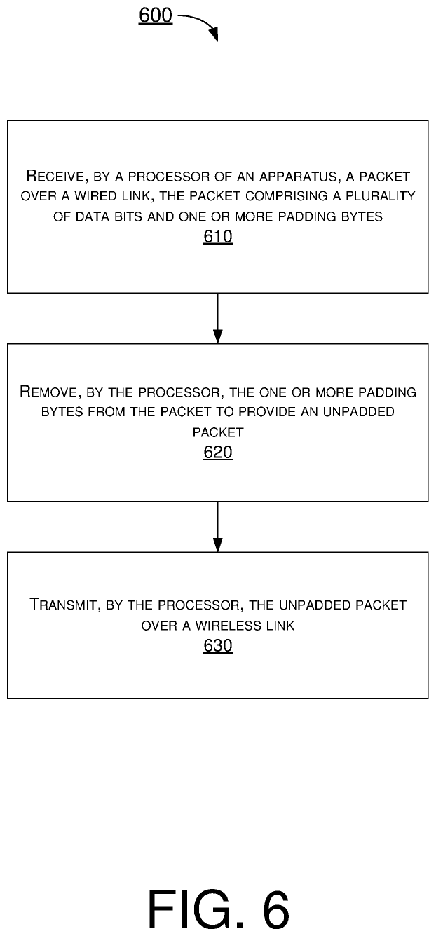

FIG. 6 illustrates an example process 600 in accordance with an implementation of the present disclosure. Process 600 may be an example implementation of the proposed schemes described above with respect to overhead reduction in transmission of small Ethernet packets in accordance with the present disclosure. Process 600 may represent an aspect of implementation of features of apparatus 510 and apparatus 520. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may also be repeated partially or entirely. Process 600 may be implemented by apparatus 510, apparatus 520 and/or any suitable wireless communication device, UE, RSU, base station or machine type devices. Solely for illustrative purposes and without limitation, process 600 is described below in the context of apparatus 510 as apparatus 210 and apparatus 520 as apparatus 220. Process 600 may begin at block 610.

At 610, process 600 may involve processor 512 of apparatus 510 receiving, via modem 518, a packet over a wired link, with the packet including a plurality of data bits and one or more padding bytes. Process 600 may proceed from 610 to 620.

At 620, process 600 may involve processor 512 removing the one or more padding bytes from the packet to provide an unpadded packet. Process 600 may proceed from 620 to 630.

At 630, process 600 may involve processor 512 transmitting, via transceiver 516, the unpadded packet over a wireless link.

In some implementations, in removing the one or more padding bytes, process 600 may involve processor 512 performing certain operations. For instance, process 600 may involve processor 512 determining whether a size of the packet is equal to a predefined size (e.g., 64 bytes). Additionally, process 600 may involve processor 512 determining whether the packet is padded. Moreover, process 600 may involve processor 512 removing the one or more padding bytes in an event that the size of the packet is equal to the predefined size and that the packet is padded.

In some implementations, the packet may include an Ethernet packet.

In some implementations, in receiving the packet over the wired link, process 600 may involve processor 512 receiving the packet from a local area network (LAN).

In some implementations, in transmitting the unpadded packet over the wireless link, process 600 may involve processor 512 transmitting the unpadded packet over a 3GPP wireless connection. Alternatively, in transmitting the unpadded packet over the wireless link, process 600 may involve processor 512 transmitting the unpadded packet over a non-3GPP wireless connection.

In some implementations, process 600 may involve processor 512 additional certain operations. For instance, process 600 may involve processor 512 receiving, via transceiver 516, one other unpadded packet over the wireless link. Moreover, process 600 may involve processor 512 inserting one or more padding bytes into the other packet to provide a padded packet having a length equal to a predefined minimum desired packet length (e.g., 42 or 46 bytes). Furthermore, process 600 may involve processor 512 transmitting, via modem 518, the padded packet over the wired link.

In some implementations, in inserting the one or more padding bytes, process 600 may involve processor 512 performing certain operations. For instance, process 600 may involve processor 512 determining whether a size of the other packet is less than a predefined size. Additionally, process 600 may involve processor 512 inserting the one or more padding bytes in an event that the size of the other packet is less than the predefined size.

In some implementations, the predefined minimum desired packet length may be a minimum Ethernet packet size.

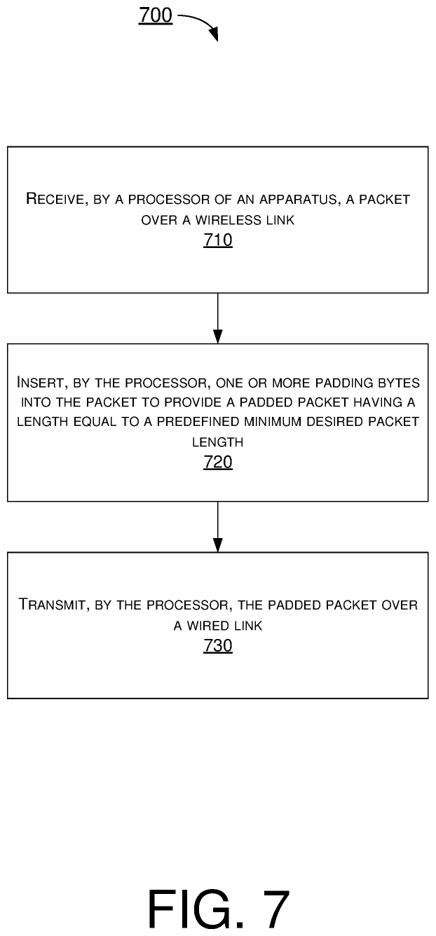

FIG. 7 illustrates an example process 700 in accordance with an implementation of the present disclosure. Process 700 may be an example implementation of the proposed schemes described above with respect to overhead reduction in transmission of small Ethernet packets in accordance with the present disclosure. Process 700 may represent an aspect of implementation of features of apparatus 510 and apparatus 520. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks of process 700 may executed in the order shown in FIG. 7 or, alternatively, in a different order. Process 700 may also be repeated partially or entirely. Process 700 may be implemented by apparatus 510, apparatus 520 and/or any suitable wireless communication device, UE, RSU, base station or machine type devices. Solely for illustrative purposes and without limitation, process 700 is described below in the context of apparatus 510 as apparatus 210 and apparatus 520 as apparatus 220. Process 700 may begin at block 710.

At 710, process 700 may involve processor 522 of apparatus 520 receiving, via transceiver 526, a packet over a wireless link. Process 700 may proceed from 710 to 720.

At 720, process 700 may involve processor 522 inserting one or more padding bytes into the packet to provide a padded packet having a length equal to a predefined minimum desired packet length. Process 700 may proceed from 720 to 730.

At 730, process 700 may involve processor 522 transmitting, via modem 528, the padded packet over a wired link.

In some implementations, in inserting the one or more padding bytes, process 700 may involve processor 522 performing certain operations. For instance, process 700 may involve processor 522 determining whether a size of the packet is less than a predefined size (e.g., 64 bytes). Moreover, process 700 may involve processor 522 inserting the one or more padding bytes in an event that the size of the packet is less than the predefined size.

In some implementations, the predefined minimum desired packet length may be a minimum Ethernet packet size.

In some implementations, the packet may include an Ethernet packet.

In some implementations, in receiving the packet over the wireless link, process 700 may involve processor 522 receiving the packet over a 3GPP wireless connection. Alternatively, in receiving the packet over the wireless link, process 700 may involve processor 522 receiving the packet over a non-3GPP wireless connection.

In some implementations, in transmitting the padded packet over the wired link, process 700 may involve processor 522 transmitting the padded packet from a local area network (LAN).

In some implementations, process 700 may involve processor 522 performing additional operations. For instance, process 700 may involve processor 522 receiving, via modem 528, one other packet over the wired link, with the packet including a plurality of data bits and one or more padding bytes. Moreover, process 700 may involve processor 522 removing the one or more padding bytes from the other packet to provide an unpadded packet. Furthermore, process 700 may involve processor 522 transmitting, via transceiver 526, the unpadded packet over the wireless link.

In some implementations, in removing the one or more padding bytes, process 700 may involve processor 522 performing certain operations. For instance, process 700 may involve processor 522 determining whether a size of the other packet is equal to a predefined size (e.g., 64 bytes). Additionally, process 700 may involve processor 522 determining whether the other packet is padded. Moreover, process 700 may involve processor 522 removing the one or more padding bytes in an event that the size of the other packet is equal to the predefined size and that the other packet is padded.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a packet over a wired link, the packet comprising a plurality of data bits and one or more padding bytes;
removing, by the processor, the one or more padding bytes from the packet to provide an unpadded packet; and
transmitting, by the processor, the unpadded packet over a wireless link.

2. The method of claim 1, wherein the removing of the one or more padding bytes comprises:
determining whether a size of the packet is equal to a predefined size;
determining whether the packet is padded; and
removing the one or more padding bytes in an event that the size of the packet is equal to the predefined size and that the packet is padded.

3. The method of claim 1, wherein the packet comprises an Ethernet packet.

4. The method of claim 1, wherein the receiving of the packet over the wired link comprises receiving the packet from a local area network (LAN).

5. The method of claim 1, wherein the transmitting of the unpadded packet over the wireless link comprises transmitting the unpadded packet over a 3^{rd} Generation Partnership Project (3GPP) wireless connection.

6. The method of claim 1, wherein the transmitting of the unpadded packet over the wireless link comprises transmitting the unpadded packet over a non-3^{rd} Generation Partnership Project (non-3GPP) wireless connection.

7. The method of claim 1, further comprising:
receiving, by the processor, one other unpadded packet over the wireless link;
inserting, by the processor, one or more padding bytes into the other packet to provide a padded packet having a length equal to a predefined minimum desired packet length; and
transmitting, by the processor, the padded packet over the wired link.

8. The method of claim 7, wherein the inserting of the one or more padding bytes comprises:
determining whether a size of the other packet is less than a predefined size; and
inserting the one or more padding bytes in an event that the size of the other packet is less than the predefined size.

9. The method of claim 7, wherein the predefined minimum desired packet length is a minimum Ethernet packet size.

10. A method, comprising:
receiving, by a processor of an apparatus, a packet over a wireless link;
inserting, by the processor, one or more padding bytes into the packet to provide a padded packet having a length equal to a predefined minimum desired packet length; and
transmitting, by the processor, the padded packet over a wired link.

11. The method of claim 10, wherein the inserting of the one or more padding bytes comprises:
determining whether a size of the packet is less than a predefined size; and
inserting the one or more padding bytes in an event that the size of the packet is less than the predefined size.

12. The method of claim 10, wherein the predefined minimum desired packet length is a minimum Ethernet packet size.

13. The method of claim 10, wherein the packet comprises an Ethernet packet.

14. The method of claim 10, wherein the receiving of the packet over the wireless link comprises receiving the packet over a 3^{rd} Generation Partnership Project (3GPP) wireless connection.

15. The method of claim 10, wherein the receiving of the packet over the wireless link comprises receiving the packet over a non-3rd Generation Partnership Project (non-3GPP) wireless connection.

16. The method of claim 10, wherein the transmitting of the padded packet over the wired link comprises transmitting the padded packet from a local area network (LAN).

17. The method of claim 10, further comprising:
receiving, by the processor, one other packet over the wired link, the packet comprising a plurality of data bits and one or more padding bytes;
removing, by the processor, the one or more padding bytes from the other packet to provide an unpadded packet; and
transmitting, by the processor, the unpadded packet over the wireless link.

18. The method of claim 17, wherein the removing of the one or more padding bytes comprises:
determining whether a size of the other packet is equal to a predefined size;
determining whether the other packet is padded; and
removing the one or more padding bytes in an event that the size of the other packet is equal to the predefined size and that the other packet is padded.

19. An apparatus, comprising:
a transceiver configured to transmit and receive over a wireless link;
a modem configured to transmit and receive over a wired link; and
a processor coupled to the transceiver and the modem, the processor configured to perform operations comprising:
receiving, via the modem, a first packet over the wired link, the first packet comprising a plurality of data bits and one or more first padding bytes;
removing the one or more first padding bytes from the first packet to provide an unpadded packet; and
transmitting, via the transceiver, the unpadded packet over the wireless link.

20. The apparatus of claim 19, wherein the processor is further configured to perform operations comprising:
receiving, via the transceiver, a second packet over the wireless link;
inserting one or more second padding bytes into the second packet to provide a padded packet having a length equal to a predefined minimum desired packet length; and
transmitting, via the modem, the padded packet over the wired link.
